(19) United States
(12) Patent Application Publication
(10) Pub. No.: US 2018/0218464 A1
(43) Pub. Date: Aug. 2, 2018

(54) Computer based system for evaluating options in an eclectic array of product and service attributes in the travel services industry

(71) Applicants: Jaivin Anzalota, Groveland, MA (US); Austin Schneider, Martinez, GA (US)

(72) Inventors: Jaivin Anzalota, Groveland, MA (US); Austin Schneider, Martinez, GA (US)

(21) Appl. No.: 15/417,762

(22) Filed: Jan. 27, 2017

(51) Int. Cl. G06Q 50/14; G06Q 10/02; G06Q 30/06

(52) U.S. Cl. CPC G06Q 50/14; G06Q 10/025; G06F 3/04817; G06Q 30/0629; G06Q 30/0641

(57) ABSTRACT

The invention is a computer-based system for collecting, archiving, analyzing and distributing travel-related information which is comprised of an application programming interface (API) that provides scores and evaluations on travel amenities, duration and other flight attributes that can be integrated into the search engines and reservations systems of airlines and other travel service providers. The API computes scores (numerical, graphical and text) relating to customer satisfaction with various attributes of travel, including flight schedules and amenities and outputs data in such a way that integrators can display these in flexible ways for their customers to readily understand their options using icons, text or numerical means. Uniquely, the information is available to system integrators across multiple platforms and is available for all segments, legs and itineraries.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

The present invention is a computer based system and method for evaluating options in an eclectic array of product and service attributes in the travel services industry. As such its components include a data structure for associating descriptive information, as well as numerical ratings based upon algorithms to create scores developed from weighting of relative ratings of flights based on comfort (plane, seats, layout), amenities (entertainment, plugs, Wi-Fi, food) and duration (duration of flight relative to fastest on that route). The system and method is further comprised of an interface based upon the JSON specification (JavaScript Object Notation). JSON is an open standard format that uses human-readable text to transmit data objects consisting of attribute-value pairs. It is a primary data format used for client/server communication.

In the travel industry, it is customary to provide multiple price structures for different levels of services. For example one can purchase a seat on an airline in the coach section or in the first class section. This has expanded to include up-charges for extra baggage, for special seats (as near exit rows), for early boarding privileges, in-flight movies, etc. Thus far however, it has not been possible either within the industry or for customers to obtain an unbiased evaluation of the various options available to them when searching for flights and planning their itineraries. In particular, evaluative information that is tailored to their specific aircraft, flight and departure or destination locations is unavailable. Furthermore, it has not previously been possible to provide a concise means for presenting composite scores either numerically or graphically that adequately convey satisfaction with a particular set of features or amenities.

Data structures common to the airline industry in which travel itineraries are decomposed into legs and segments (in the cited cases for pricing comparisons) are described in the following two patents. Note that taking into account user preferences is one aspect of these patents; but, the intent is for comparing prices rather than for describing amenities and other features of comfort as in the present invention. Note also that the search technology for comparing pricing solutions (directed acyclic graph) is also different from that used in the present invention. Furthermore, the present invention provides an API for flexible adaptation to a variety of platforms and applications.

U.S. Pat. No. 6,275,808 B1—DeMarcken Carl G., Aug. 14, 2001 entitled: “Pricing graph representation for sets of pricing solutions for travel planning system.” An airline travel planning system is described in which a server computer executing a server process including a search process to search for set of pricing solutions in accordance with at least one destination and at least one origin. Several processes are described including a process responsive to user preferences and to a set of pricing solutions that provides pricing solutions sorted by said user preference, a process that sorts set of pricing solutions to produce a subset of said set of pricing solutions in accordance with user specified preferences.

U.S. Pat. No. 8,571,903 B1—DeMarcken, Carl G., Oct. 29, 2013 entitled: “Pricing graph representation for sets of pricing solutions for travel planning system.” An airline travel planning system is described in which a server computer executing a server process including a search process to search for set of pricing solutions in accordance with at least one destination and at least one origin. The search process represents the set of pricing solutions in the form of a directed acyclic graph. The system also includes a client computer executing a client process on the set of pricing solutions. The client process has a manipulation process that manipulates the set of pricing solutions in response to user preferences.

### BRIEF SUMMARY

The present invention is part of an over-all system that provides a means for collecting data on flight attributes, storing and analyzing said data and presenting outputs that may be used by integrators in comparing various features of flights including cost, schedule and amenities to address the needs of specific customers.

The methods for integrating the computation of Flight characteristics, Flight Scores and Flight Amenities is one component of the system that is comprised of three parts: the Scores and Amenities API, the Hub; and the Routehappy Hub API. The present invention provides a means to gather flight information, identify features that may contribute to customer satisfaction, present those options for each leg of a flight, computes Flight Scores and provide a means to present these options to make it easy for flyers to find the best possible flights on any route worldwide. The scores are based on various components of the flight experience (Flight Amenities), including seat, aircraft, various amenities, and flight duration. Flights are scored on a leg basis, i.e. flights with connections have a single score. The invention captures and maintains these granular details and makes them available for each flight segment or leg of the itinerary.

The Scores and Amenities API, hereinafter called the “S&A API” is a tailor-made programming interface for travel service providers (e.g. airlines and search services like Expedia, Kayak, et al.) to access disparate data that relates to customer satisfaction.

The S&A API computes scores (numerical, graphical and words) relating to customer satisfaction with various attributes of travel including flight schedules and amenities and outputs data in such a way that system integrators can display these in flexible ways for their customers to readily understand their options using icons, text or numerical means.

The details of one or more implementations are set forth in the accompanying drawings and the description below. Other features, objects, and advantages will be apparent from the specification, description and drawings and from the claims.

An alternate description of the scope of the invention is a computer system for collecting, archiving, analyzing and distributing travel-related information which includes a computer and a computer readable medium storing a computer program in which the computer program has instructions that causes the computer to accept inputs on flight amenities, include an evaluation and make scores and data available for all slices of a journey, providing an output that system integrators can incorporate into their own websites and reservation systems.

### BRIEF DESCRIPTION OF DRAWINGS

FIG. 1 illustrates the steps in the decomposition of the itinerary into components that are subsequently used for various aspects of the program.

FIG. 2 provides details of data flow from various sources into the system.

FIG. 3 provides details of the amenities and other flight attributes that are stored in databases and indicates certain processes.

FIG. 4 provides the flow of data and means for computing a flight duration weighting factor.

FIG. 5 is a diagram indicating various Scoring and Processing algorithms.

FIG. 6 provides an overview of the Integrator Request and API Response.

FIG. 7 illustrates Flight Scores Presentation Options for Integrators.

FIG. 8 provides examples of implementations of the Scoring system. FIG. 8a is a composite view. FIG. 8b illustrates the pop-up menu for amenities and FIG. 8c illustrates a pop-up providing details on the score.

### DETAILED DESCRIPTION OF THE INVENTION

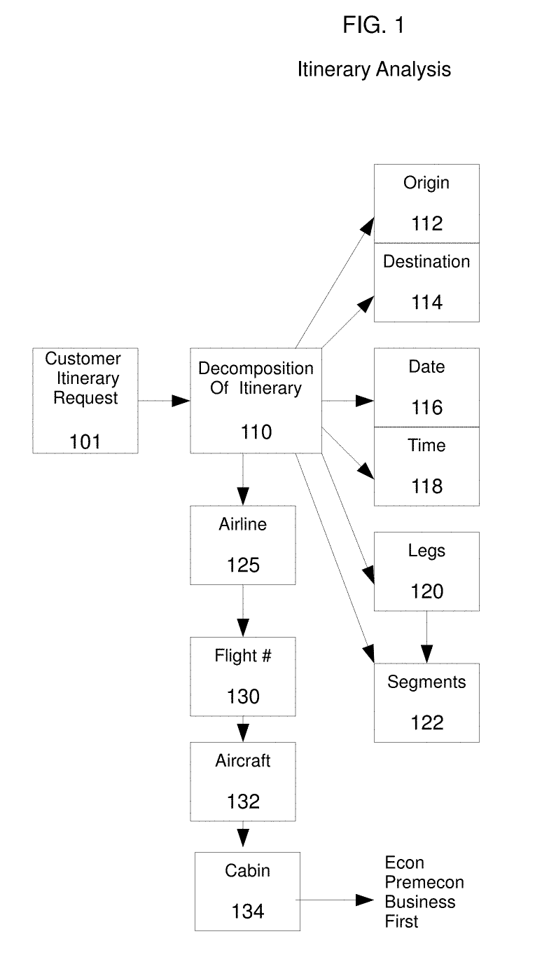

A detailed description of the invention follows. FIG. 1 illustrates the steps in the decomposition of the itinerary into components that are subsequently used for various aspects of the program. The customer specifies a point of departure (112) and a destination (114) for a given date (116) and time (118) in a typical flight search engine as might be used by a customer or a ticketing agent (101). The airline reservations system then looks for matches that meet these requirements. In the present invention, a means is provided to enable an Integrator (such as an airline or travel services employee to extract information from a proprietary database that associates particular flight characteristics and amenities with a given flight number (130), aircraft (132) and cabin (134) for each leg (120) and segment (122) for a given airline (125) and flight number (130) that meets the requirements. The cabin (134) options are: Economy, Business, First Class or Premier Economy (Premecon).

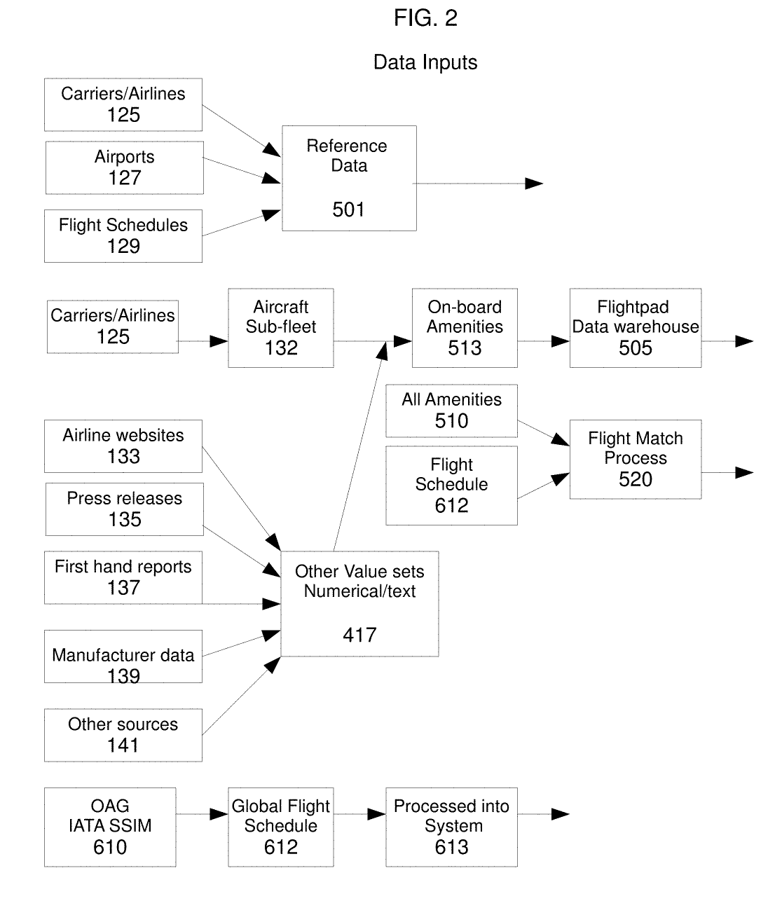

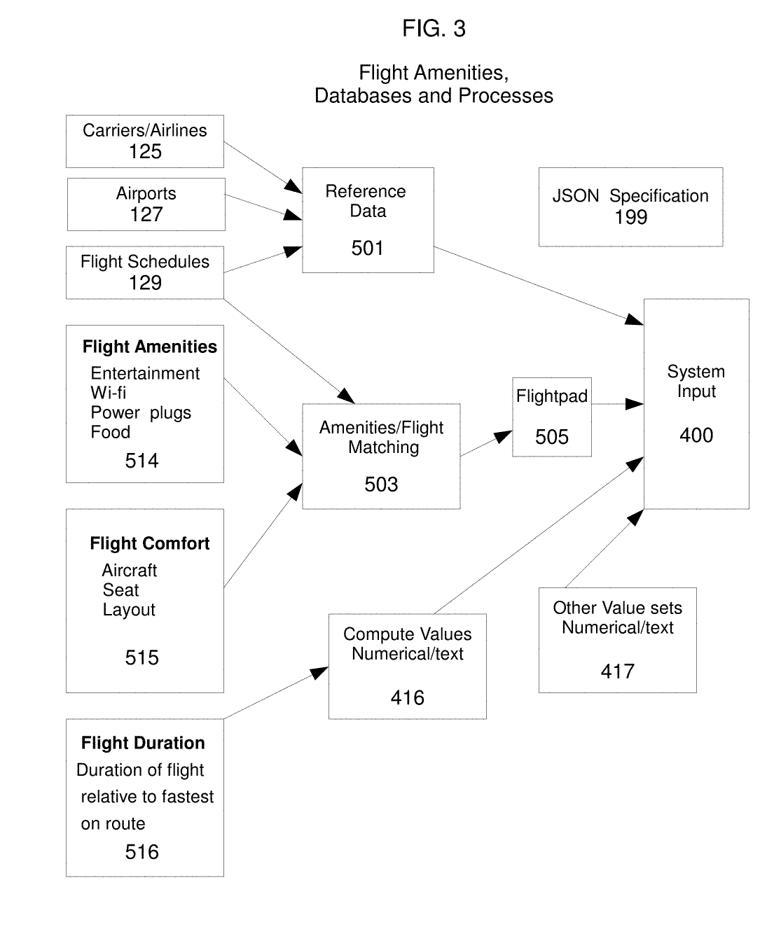

FIG. 2 provides an overview of data inputs from various sources to the system. The Reference database (501) includes inputs from carriers/airlines (125), airports (127) and flight schedules (129). Carriers/airlines (125) are also the source of specific aircraft in their fleet (132) as well as on-board amenities (513) which include both available amenities as delineated in 514 of FIG. 3 as well as physical lay-out factors (515) also indicated in FIG. 3. The combined amenities are stored in a data warehouse (505) which is referred to as the Flightpad.

Sets of data (417) indicating value of various attributes of a flight are also collected and fed into the Flightpad data warehouse (505). The inputs to this collection include airline websites (133), press releases (135), first hand reports (137), manufacturer data (139) and Other sources (141).

A third major collection of data is from the Official Airline Guide (OAG) organization (610) that publishes flight information according to the IATA SSIM standard format. Global flight schedules (612) are processed as inputs to the S&A API system (613).

FIG. 3 provides details of the amenities and other flight attributes that are stored in databases associated with the API along with some of the processes. It is noted that the system is compliant with the JSON convention (199) for formatting data in a manner compatible with industry standards. Other standards and cross platform compatibility attributes may also be incorporated. Flight amenities (514) and Flight comfort attributes (515) are among the collected amenities that go through a Data matching process (503) and then are stored in the Flightpad database (505). Amenities are mapped to the flight schedule using a process called Flightmatch (503). The Flightpad data base (505) may be accessed by a system Integrator using the S&A API and stored information incorporated into the output of the Integrator's system (400).

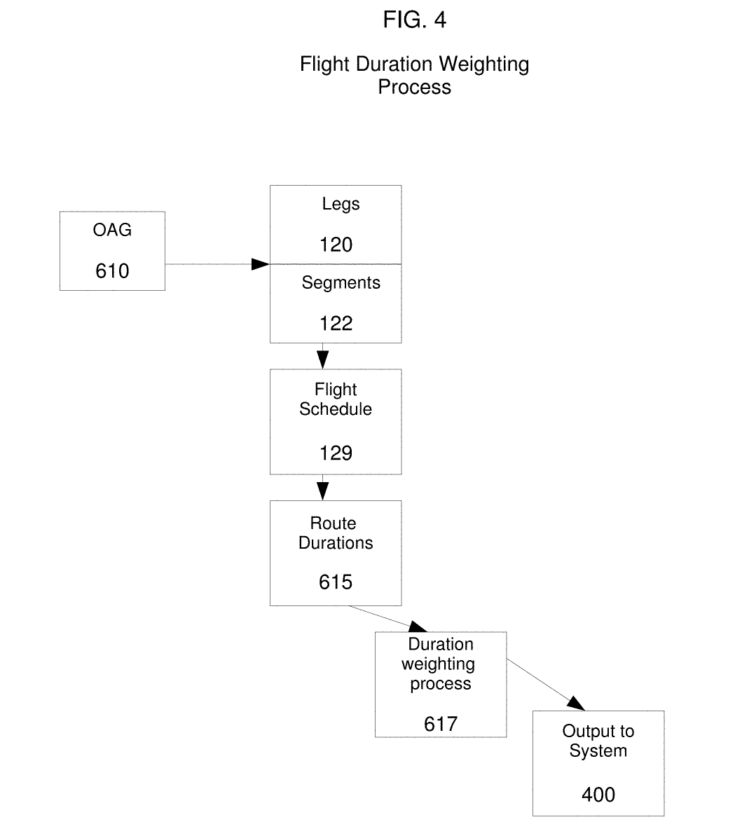

A means is also provided to gather data on flight duration (516) and issue a numerical indicator (416) of how fast the flight is relative to the fastest on a particular route. The indicator is simply a duration that represents the fastest way to get from point A to B. The system stores Origin and Destination (O&D) durations for pairs that are achievable within up to 2 stops by day of week. For example, the fastest scheduled flight from BOS-JFK is 72 minutes. Business logic (416) is used to assess the duration of a given leg compared to the fastest leg on a route, and scored accordingly. Flight durations are calculated based on the current schedule given. This process is further indicated in FIG. 4.

Not shown is a feature of the invention that provides a means to indicate an assessment of a particular amenity or comfort attribute for a flight when there is a difference of the amenities offered on each segment of a particular leg.

FIG. 4 provides the flow of data and means for computing flight duration weighting factors. The inputs to the Flightpad database and data structure (505) are indicated as in FIGS. 2 and 3. Additionally illustrated is the capture of data from the Official Airline Guide (610) organization that provides data on all flights nearly everywhere across the earth. From their database one can extract specific data on flights including Origin and Destinations, legs (120), segments (122), flight schedules (129) and route durations (615) as well as airlines (125), aircraft (132), and airports (127)—see FIG. 2. From the route durations data, one can determine durations of each flight and compare them. In one instance of the present invention, a numerical and/or textual value is given that indicates the relative duration compared to the shortest duration available. This value may count up to half of the total flight score. Values are output to the System (400).

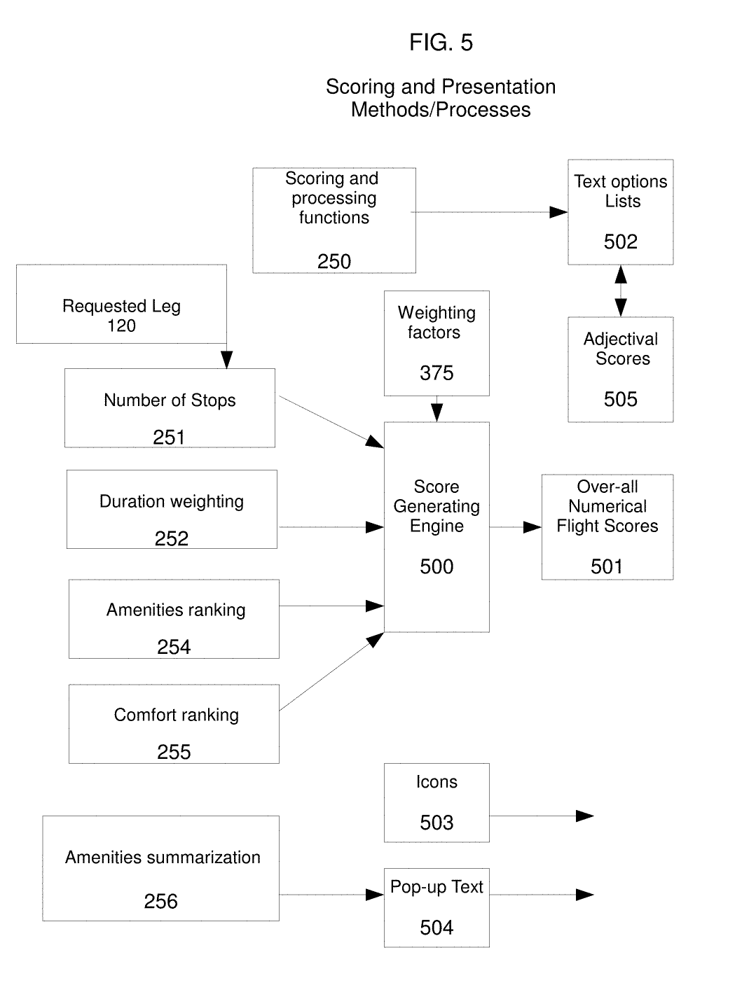

FIG. 5 is a diagram indicating various scoring, presentation and processing methods. One such method has already been indicated; namely, the duration weighting method (252). A second method provides a ranking of amenities (254). For example, which is more important having power outlets for one's Wi-Fi device or having good entertainment? Another set of factors that contributes to comfort (255) is evaluated as well. These factors as listed in (515) of FIG. 3 are related to Aircraft, Seats and Layout. Seat width for example is indicated as “standard” or “wider”. Seat attributes are weighted higher than amenities, while all amenities are weighted equally. In other words, final scores are biased toward relative comfort over amenities, however, flights with both above average comfort and best amenities score highly.

Amenities may be assigned a value based upon whether it is available or not. Fresh food amenity for example takes on a value for its existence as either, “No”, “Partial”, or “Yes”. On the other hand the existence of Wi-Fi may be either “yes” or “no” for a particular segment but its availability is based on whether Wi-Fi is installed and whether the flight is within the coverage area. One segment may have it available and another may not; so the score for the Leg may vary. These Amenity considerations (254) are merged with Trip duration (252), Comfort considerations (255) along with Number of Stops (251) and possibly other Weighting Factors (375) in the Score Generation Engine (500) which uses a weighting algorithm to come up with a single Over-all Numerical Flight Score (501) for the leg. This Over-All score is in the range of 1.0 to 10.0 with 10.0 being the best possible score. Scores are created on demand as requested.

Additional scoring and processing functions (250) develop lists of text options (502) and/or adjectival scores (505) that are relevant for each of the various amenities and comfort factors. See for example the descriptors of the various amenities in Table 9.

The amenities summarization process (256) is comprised of icons (503) and pop-up text (504) that appears when one hovers over the icons with a navigation mouse/cursor. For example when a flight for a given route with connecting flights is displayed hovering over the icons reveals as text message such as “Wi-Fi available”, “Fresh food mostly available”, “Power mostly available”, etc. The text provided is based in part on the percentage of flight time an amenity is available. The “pop-up” text is an optional implementation. The summary attributes delivered by the API enable this capability. The icons (503) are graphical images representing various amenities or flight attributes such as an icon for food, Wi-fi, etc. and may be added or altered by the customer integrator. They are not a part of the API delivery.

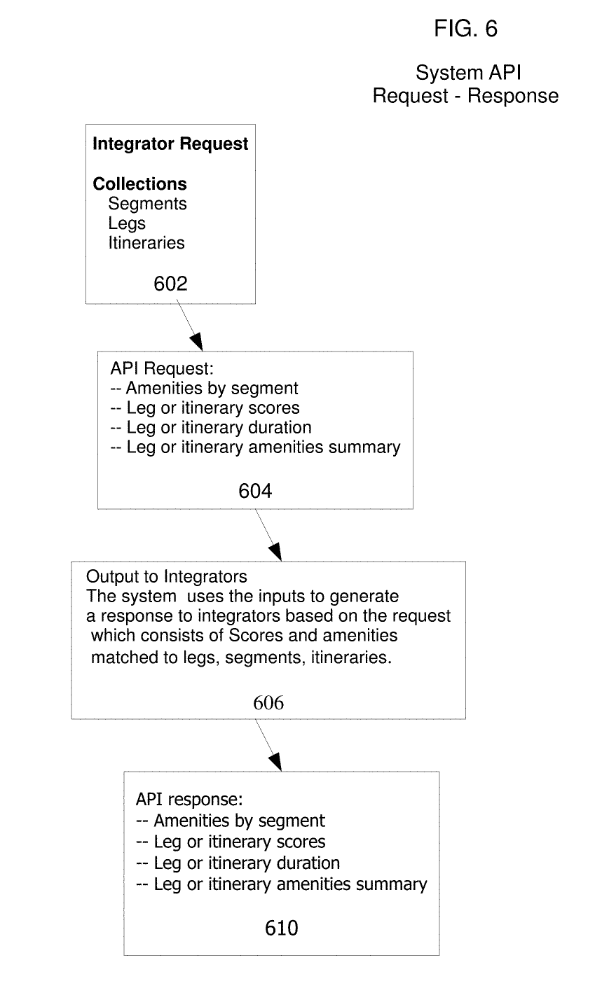

FIG. 6 provides an overview of the Integrator Request (602) which generates an API Request (604) and provides an output to the Integrator (606) and a response from the API (610). It is noted that the system is comprised of collections of segments, legs and itineraries as seen in 602 and draws upon data stored or computed for segments and legs. Such data includes listings of amenities, leg or itinerary scores, leg or itinerary duration and leg or itinerary amenities summary. The Integrator may select the scores and amenities to be displayed and matched to legs, segments and/or itineraries. Thus when a user accesses the travel reservation system, the API provides the add-on information to the flight search results which as indicated in 610 includes the amenities by segment, leg or itinerary scores, leg or itinerary duration and leg or itinerary amenities summary.

Table 1 describes the terminology and further describes the format for the data comprised in an Integrator Request. The request is a comma delimited list of segment, leg, or itinerary keys. The leg and itinerary key have other delimiters “˜” and “.” respectively.

TABLE 1
Terminology

| Term | Description |
|---|---|
| segment key | The departure and arrival airport codes, marketing |
| | carrier code, marketing flight number, departure |
| | date (in YYYYMMDD format) and cabin key, e.g. |
| | BOS-DEN-DL-123-20990224-ECON. Note: Flight |
| | numbers with leading zeroes or alpha characters are |
| | not supported. For example, 0027 or UA27 must be |
| | formatted as 27. Also, be sure to use the actual |
| | departure date of the segment when constructing |
| | segment IDs. Often the departure date of the first |
| | segment is different from the departure date of |
| | the last segment in a multi-segment leg. |
| leg key | One or more segment keys, delimited by “~” e.g. BOS- |
| | DEN-DL-123-20990224-ECON~DEN-JFK-US-456- |
| | 20990224-PREMECON |
| itinerary key | One or more leg keys, delimited by “.” e.g. BOS-DEN- |
| | DL-123-20990224-ECON.DEN-BOS-DL-456-20990305- |
| | ECON |
| cabin key | ECON, PREMECON, BUSINESS, or FIRST |

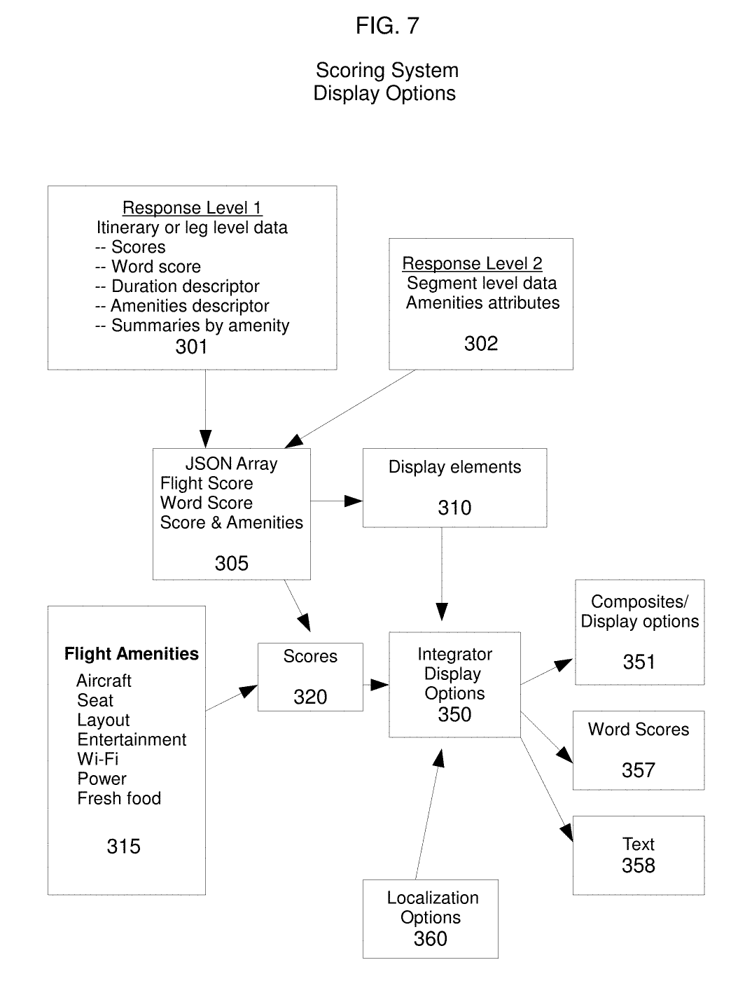

FIG. 7 illustrates Flight Scores Presentation Options for Integrators. It is noted that there are a number of Display Options (350) that might be used by an integrator who is compiling scores for various flight/itinerary options, however the API may not provide them. Rather, the API provides the data attributes that enable the Integrator to use them. The response is organized at two levels:

Level 1 (301) is the itinerary or leg level data comprised of
Scores
Word score
Duration descriptor
Amenities descriptor
Summaries by amenity
   Level 2 (302) is the segment level data and is comprised of
Amenities attributes

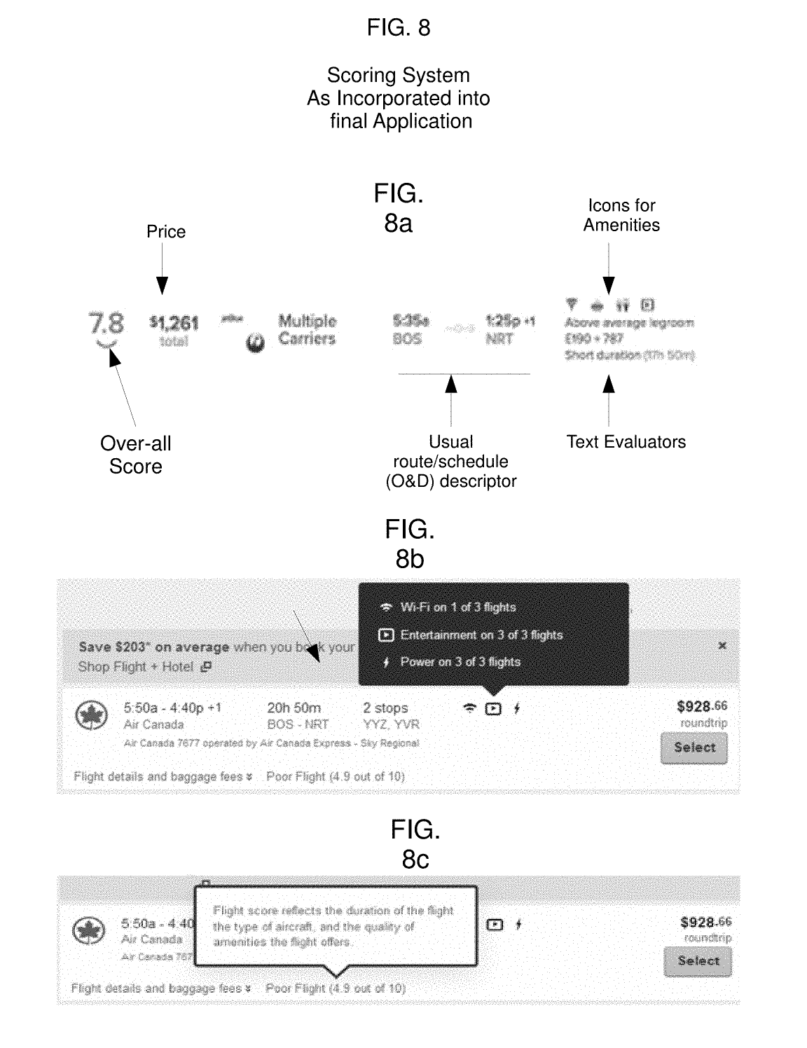

Display options include one or more of the following: a composite (351), a single word (357) or text/phrase (358). A graphical representation of some of these is indicated in FIG. 8. Some of the scores are stored in a JSON Array (305) and are computed on demand. Display elements (310) may be drawn up from an external database of icons representing the various amenities such as a picture of a seat for the seat description. A list of the amenities which have associated icons is indicated (315). The attributes for the amenities that are used in scoring (320) are indicated in the Tables presented below.

The S&A API conforms to the JSON API specification. (http://jsonapi.org/). This includes coding format for versions, authentication and compression (using HTTP compression).

It is noted that Localization options (360) enable a user to select from among a number of languages to present the text information.

FIG. 8 provides a view of how the scores might be incorporated into the website of a travel reservations system, an airline, global distribution system (GDS) or Corporate Booking Tools. There are many use cases and ways to integrate the proprietary content and data. Each customer can customize their integrations to meet their own business goals and fit seamlessly within their user interface. An example of one such application is provided below in FIG. 8.

In the case shown at the top (FIG. 8a) a customer is looking for flights between Boston (BOS) and Narita International Airport in Japan (NRT) that departs Boston at 5:35 am. The over-all score is indicated to the left of the price. Commentary regarding the flight is provided on the right side. Icons are shown across the top for the amenities and textual comments are provided below. Note that the bottom textual comment is both adjectival (“short duration”) and quantitative (10 h 50 m).

In the middle case shown in FIG. 8b, a search on Expedia provided a number of flight options between BOS and NRT. By clicking on the icons, a pop-up box explains that Wi-Fi is available on “1 of 3 flights”, Entertainment is on “3 of 3 flights” and “Power is on 3 of 3 flights.”

Looking to the bottom case on FIG. 8c, the same flight as above is given a Poor rating and the over-all score of “4.9 out of 10.” Thus, it is seen that the Integrator has flexibility in how they display the information and which information to display. The pop-up box in this case indicates that: “Flight score reflects the duration of the flight the type of aircraft, and the quality of amenities the flight offers.”

Further definition and description of the foregoing is provided in the tables and lists that follow.

### S&A API Introduction

The following section describes how a client would request resources, and how the server will respond to those requests. One must first obtain an API key, sign up for access or sign in to one's account dashboard using the credentials established when the account was created.

TABLE 2
Headers

| Name | Required | Description |
|---|---|---|
| Accept | Yes | Specifies the media type and version. Must be |
| | | application/vnd.api.v3+json for this version |
| | | of the API. |
| Auth | Yes | Your API key. |
| Accept- | No | Used for translation of the display_text |
| Language | | properties. The use of this header is |
| | | documented under RFC 3282. |
| Accept- | No | All API requests support gzip and deflate HTTP |
| Encoding | | compression. To receive compressed response |
| | | bodies, send the gzip, deflate. The type of |
| | | compression used will be in the Content- |
| | | Encoding response header. |

This section describes the structure of an API document. API documents are defined in JavaScript Object Notation (JSON) [RFC 7159].

TABLE 3
Document Structure - Top Level

| Property | Type | Description |
|---|---|---|
| data | array | The document's “primary data.” A collection of |
| | | resources targeted by a request. |
| linked | object | Resource objects that are related to the primary data |
| | | and/or each other (“included resources”). |

Resource objects contain an id property and any number of other attributes, depending on the resource type. An example for seat resource is given in Table 4.

TABLE 4
Resource Objects - Seat Example

{

“id”: 2,
“display_text”: “Above average legroom (32\″)”,
“quality”: “better”,
“legroom”: “more”,
“pitch”: “32”,
“width”: “standard”,
“flatness”: “not flat”,
“type”: “above average legroom”,
“updated_at”: “2016-07-01T06:09:52Z”

}

In addition, a resource may also contain a links property, an object containing links related to the resource. Table 5 is an example of a segment resource, containing a seat link:

TABLE 5
Segment Resource with Seat Link

{

“id”: “PHX-MCO-AA-436-20161215-ECON”,
“links”: {

“seat”: 2

}

}

Data can be fetched by sending a GET request to an endpoint. As an example, the following request illustrated in Table 6 fetches a collection of segments:

TABLE 6
Fetching Data

| | |
|---|---|
| curl | \ |
| -H | “Auth: YOUR_API_KEY” \ |
| -H | “Accept: application/vnd.api.v3+json” \ |
| -G | \ |
| -d | ids=PHX-MCO-AA-436-20161215-ECON \ |

YOUR_HOST/segments

### Collections

The API is comprised of Collections of
Legs (of flights)
   Related Resources
   Fetching Related Resources
Itineraries Collection
   Related Resources
   Fetching Related Resources
Segments (of flights)
   Related Resources
   Fetching Related Resources

Common to these collections are various attributes that are evaluated as part of the scoring process. These are displayed as Description/Value sets which may for example be a numerical value, an adjectival value or as one of the options from a list such as “present,” “not present” or “unknown.”

word score

amenity

speed

seat_summary

entertainment_summary

power_summary

wifi_summary

aircraft_summary

layout_summary

fresh_food_summary

These may be further broken down into attributes and sets of values for each. These are then associated with the a leg of a flight, a segment and/or an itinerary as appropriate.

segments

segments.aircraft

segments.entertainment

segments.fresh_food

segments.layout

segments.power

segments.seat

segments.wifi

As an example, the seat quality might include such characteristics ratings as indicated in Table 4 above. Namely,
“quality”: “better”,
“legroom”: “more”,
“pitch”: “32”,
“width”: “standard”,
“flatness”: “not flat”,

### Aircraft

Returning to FIG. 1, the Aircraft (132) attribute is further described in Table 7. The Aircraft type/quality amenity covers helicopters to the newest wide-body jets. Aircraft with above-average amenities, such as higher cabin pressure, higher humidity and larger windows, are viewed as more favorable than those without these amenities.

TABLE 7
Aircraft - Available Data Elements

| Attribute | Value(s) | Description |
|---|---|---|
| id | e.g. 1 | Unique numerical identifier |
| display_text | e.g. “A320 (narrow body)” | Up to 30-character string |
| | | (English) See character |
| | | limits by language |
| quality | n/a, better, standard | An assessment of the |
| | | aircraft cabin_pressure |
| | | and window_size |
| type | bus, helicopter, jumbo, | The type/size of equipment |
| | larger regional jet, n/a, | operated (note: bus and |
| | narrowbody, smaller | train are available for |
| | regional jet, train, | codeshare land connections) |
| | turbo/prop, widebody | |
| cabin_pressure | n/a normal enhanced | An assessment of the |
| | unpressurized | aircraft's cabin pressure |
| window_size | n/a, standard, larger, | An assessment of the |
| | smaller | aircraft's window size |
| updated_at | ISO 8601 formatted field | Indicates when the data |
| | e.g. 2015-11-04T09:20:22Z | element was last updated |

### Amenities Endpoints

These endpoints return all Flight Amenity level resources.

Request

GET/aircrafts

GET/layouts

GET/seats

GET/entertainments

GET/wifis

GET/powers

GET/fresh_foods

Response

The available data elements for the foregoing endpoints are detailed in the system documentation An example for in this case, “Aircraft” has already been given in Table 7 above.

### Multi-Lingual Flight Amenities

Another feature of the invention is that all user facing text values have been translated to a comprehensive set of languages to simplify rollout and maintenance. The Scores & Amenities API includes the ability to request Flight Amenity display_text, duration descriptor, and Flight Score word_score values in 24 languages.

### Summarization of Flight Amenities

Flight amenity summarization makes it easy to describe what amenities are available at the leg (multi-segment trip) or itinerary (multiple legs) level. The legs and itineraries endpoints provide resource attributes that “rollup” segment level Flight Amenities in a simple, easy to understand format.

TABLE 8
Example of Summarization

| Leg | Amenity | Summary |
|---|---|---|
| Pan Am BOS-JFK, JFK-DXB | Seat | “Above average legroom seat” |

In the example above (Table 8) the leg Pan Am BOS-DXB via JFK is a 1 stop trip offering a different seat types on each segment. BOS-JFK is Above average legroom (32″) and JFK-DXB is Above average legroom (34″). Since both seats are categorized as “Above average legroom” our business logic determines that this is the best summarization of the seat types. This is the simplest example and the system is designed to deal with the cases of wide variability in seat type (and all other amenities) seamlessly. For Wi-Fi, Power, Entertainment, and Fresh Food, the API also provides a simple exists=yes, partially, no so that users can quickly determine whether, for example, Wi-Fi is available across a multi-segment trip.

### Other Features

The scoring algorithm has been fine tuned to account for the evolving complexities of Flight Amenity data, including whether an amenity is free or paid, the general availability of an amenity in a market, e.g. Wi-Fi is not available within Australia, and much more.

### An Example of the Legs Collection

The Legs collection is further described below. It is initiated by the following command.

GET/legs/:ids

This endpoint returns a legs collection. :ids is a comma-delimited list of IDs. An ID is a leg key, which is a tilde-delimited list of segment keys.
Here is an example of a leg with two segments:

BOS-DEN-DL-123-20990224-ECON˜DEN-SFO-DL-456-20990225-PREMECON

When requesting a direct flight (any leg which includes a stop at an intermediate point with no change in flight number), one must construct the leg using two (or more) segments. For example, if BOS-ORD-UA-123-20990224-ECON were a direct flight with a stop at JFK, the leg should be constructed as BOS-JFK-UA-123-20990224-ECON˜JFK-ORD-UA-123-20990224-ECON.

### Related Resources for Legs

In the following example, a session is illustrated of sending a request to the S&A API system for a particular leg of a flight requesting a score on two features and receiving a response. In this instance both a word score and a numerical score are provided for the seat and the availability/quality of the Wi-Fi.

This endpoint returns a legs collection. The session is initiated with a request using the following command:

GET/legs

The parameters, response and resource attributes are seen in Table 9 below.

TABLE 9
Session for Legs Endpoint
Parameters

| Name | Required | Description |
|---|---|---|
| ids | Yes | Comma-delimited list of leg keys. |
| include | No | Comma-delimited list of related resources to include. By |
| | | default, this endpoint does not return any related resources. |

Response
Resource Attributes

| | | |
|---|---|---|
| Name | Value set | Description |

Leg

| | | |
|---|---|---|
| id | e.g. BOS-JFK-UA-123-20990224-ECON~JFK- | Leg key |
| | ORD-UA-123-20990224-ECON | |

score

| | | |
|---|---|---|
| id | 1.0 to 10.0 | |
| word_score | Poor | 1.0 to 4.9 |
| | Fair | 5.0 to 5.9 |
| | Okay | 6.0 to 6.9 |
| | Good | 7.0 to 7.4 |
| | Very good | 7.5 to 8.4 |
| | Excellent | 8.5 to 10.0 |

amenity

| | | |
|---|---|---|
| id | 1 to 5 | |
| descriptor | Basic | 1 |
| | Satisfactory | 2 |
| | Good | 3 |
| | Very good | 4 |
| | Excellent | 5 |

speed

| | | |
|---|---|---|
| id | 1 to 5 | |
| descriptor | Longest duration | 1 |
| | Long duration | 2 |
| | Average duration | 3 |
| | Short duration | 4 |
| | Shortest duration | 5 |

aircraft_summary

| | | |
|---|---|---|
| id | e.g. 1 | Unique numerical identifier |
| display_text | e.g. “A320, 777” | A string of aircraft families |

seat_summary

| | | |
|---|---|---|
| id | e.g. 1 | Unique numerical identifier |
| display_text | e.g. “Mostly above | A summarization of the seat types on a leg, |
| | average legroom” | biased toward the longest segment |

layout_summary

| | | |
|---|---|---|
| id | e.g. 1 | Unique numerical identifier |
| display_text | e.g. “Mostly more space | A summarization of the layouts on a leg, |
| | (3-3-3) layout” | biased toward the longest segment |

entertainment_summary

| | | |
|---|---|---|
| id | e.g. 1 | Unique numerical identifier |
| | | Indicates whether |
| exists | no, partial, yes | entertainment is available |
| | | across a leg |
| display_text | Entertainment type display_text, | Uniform entertainment across leg |
| | e.g. “On demand entertainment” | Varying entertainment types across leg |
| | Entertainment available | Entertainment available for >=60% of leg |
| | Entertainment mostly available | Entertainment available for >0% of leg |
| | Entertainment partially available | Entertainment does not exist on leg |
| | Entertainment not available | |

wifi_summary

| | | |
|---|---|---|
| id | e.g. 1 | Unique numerical identifier |
| exists | no, partial, yes | Indicates whether Wi-Fi is |
| | | available across a leg |
| display_text | Wi-Fi type display_text, e.g. | Uniform Wi-Fi across leg |
| | “Better Wi-Fi” | Varying Wi-Fi types across leg |
| | Wi-Fi available | Wi-Fi available for >=60% of leg |
| | Wi-Fi mostly available | Wi-Fi available for >0% of leg |
| | Wi-Fi partially available | Wi-Fi does not exist on leg |
| | Wi-Fi not available | |

power_summary

| | | |
|---|---|---|
| id | e.g. 1 | Unique numerical identifier |
| exists | no, partial, yes | Indicates whether power is available |
| | | across a leg |
| display_text | Power type display_text, e.g. | Uniform power across leg |
| | “Power & USB outlets” | Varying power types across leg |
| | Power available | Power available for >=60% of leg |
| | Power mostly available | Power available for >0% of leg |
| | Power partially available | Power does not exist on leg |
| | Power not available | |

fresh_food_summary

| | | |
|---|---|---|
| id | e.g. 1 | Unique numerical identifier |
| exists | no, partial, yes | Indicates whether fresh food is |
| | | available across a leg |
| display_text | Fresh food type display_text, e.g. | Uniform fresh food type across leg |
| | “Fresh meal provided” | Varying fresh food types across leg |
| | Fresh food available | Fresh food available for >=60% of leg |
| | Fresh food mostly available | Fresh food available for >0% of leg |
| | Fresh food partially available | Fresh food does not exist on leg |
| | Fresh food not available | |

### Examples of Coding for Leg Scores

### #1 Leg Scores

In this example, a session is illustrated of sending a request to the S&A API system for a particular leg of a flight requesting a score and receiving a response. In this instance both a word score and a numerical score are provided.

TABLE 10
Legs Scores Coding - Example #1

```
Request
curl \
  -H “Auth: YOUR_API_KEY” \
  -H “Accept: application/vnd.api.v3+json” \
  -G \
  -d ids=DSM-ORD-AA-3558-20160907-FIRST~ORD-SNA-AS-1994-
20160907-ECON \
  -d include=score \
  YOUR_HOST/legs
Response
{
  “data”: [
    {
      “id”: “DSM-ORD-AA-3558-20160907-FIRST~ORD-SNA-AS-
1994-20160907-ECON”,
      “links”: {
        “score”: 7.2
      }
    }
  ],
  “linked”: {
    “scores”: [
      {
        “id”: 7.2,
      “word_score”: “Good”
      }
    ]
  }
}
```

In the following example (Table 11), a session is illustrated of sending a request to the S&A API system for a particular leg of a flight requesting a score on two features and receiving a response. In this instance both a word score and a numerical score are provided for the seat and the availability/quality of the Wi-Fi. In this instance the seat options are favorable with respect to reclining, width, pitch, flatness and legroom. Regarding the Wi-Fi, both a basic service and a “better” service option are available.

TABLE 11
Legs Scores Coding - Example #2
Fetching seat and Wi-Fi data

```
Request
curl \
  -H “Auth: YOUR_API_KEY” \
  -H “Accept: application/vnd.api.v3+json” \
  -G \
  -d ids=DSM-ORD-AA-3558-20160907-FIRST~ORD-SNA-AS-1994-
20160907-ECON \
  -d include=segments.seat,segments.wifi \
  YOUR_HOST/legs
Response
{
  “data”: [
    {
      “id”: “DSM-ORD-AA-3558-20160907-FIRST~ORD-SNA-AS-
1994-20160907-ECON”,
      “links”: {
        “segments”: [
          “DSM-ORD-AA-3558-20160907-FIRST”,
          “ORD-SNA-AS-1994-20160907-ECON”
        ]
      }
    }
  ],
  “linked”: {
    “segments”: [
      {
        “id”: “DSM-ORD-AA-3558-20160907-FIRST”,
        “links”: {
          “seat”: 20,
          “wifi”: 2
        }
      },
      {
        “id”: “ORD-SNA-AS-1994-20160907-ECON”,
        “links”: {
          “seat”: 3,
          “wifi”: 18
          }
      }
    ],
    “seats”: [
      {
        “id”: 20,
        “display_text”: “Recliner seat (37\”)”,
        “quality”: “better”,
        “legroom”: “more”,
        “pitch”: “37”,
        “width”: “n/a”,
        “flatness”: “not flat”,
        “type”: “recliner seat”,
        “updated_at”: “2016-07-01T06:09:52Z”
      },
      {
        “id”: 3,
        “display_text”: “Standard legroom (31\”)”,
        “quality”: “standard”,
        “legroom”: “standard”,
        “pitch”: “31”,
        “width”: “standard”,
        “flatness”: “not flat”,
        “type”: “standard legroom”,
        “updated_at”: “2016-07-01T06:09:52Z”
      }
    ],
    “wifis”: [
      {
        “id”: 2,
        “display_text”: “Basic Wi-Fi (fee)”,
        “quality”: “standard”,
        “performance”: “basic”,
        “cost”: “paid”,
        “exists”: “yes”,
        “chance”: “full”,
        “coverage”: “full”,
        “connectivity_type”: “wifi”,
        “type”: “wifi”,
        “updated_at”: “2016-05-31T10:03:55Z”
      },
      {
        “id”: 18,
        “display_text”: “Better Wi-Fi (fee)”,
        “quality”: “standard”,
        “performance”: “better”,
        “cost”: “paid”,
        “exists”: “yes”
        “chance”: “full”,
        “coverage”: “full”,
        “connectivity_type”: “wifi”,
        “type”: “wifi”,
        “updated_at”: “2016-05-31T10:03:55Z”
      }
    ]
  }
}
```

Similar coding is developed for each of the resource attributes.

### Itineraries Endpoint

This endpoint returns a collection of itineraries. The command, parameters, response and resource attributes are indicated in Table 12.

TABLE 12
Itineraries Endpoint - Request, Parameters and Response
Request
GET/itineraries
Parameters

| Name | Required | Description |
|---|---|---|
| ids | Yes | Comma-delimited list of itinerary keys. |
| include | No | Comma-delimited list of related resources to |
| | | include. By default, this endpoint does not |
| | | return any related resources. |

Response
Resource Attributes
itinerary

| Name | Value set | Description |
|---|---|---|
| id | e.g. BOS-JFK-UA-123-20990224-ECON~JFK- | Itinerary key |
| | ORD-UA-123-20990224-ECON | |

### Examples of Itinerary Evaluators

Two examples of the coding for making requests are provided in Tables 12 and 13. Example #1 is to request an itinerary score. Example #2 is to request seat and Wi-Fi data and summaries.

TABLE 12
Itinerary Scores Example #1

```
Request
curl \
  -H “Auth: YOUR_API_KEY” \
  -H “Accept: application/vnd.api.v3+json” \
  -G \
  -d ids=DEN-NRT-UA-139-20170206-ECON.NRT-DEN-UA-138-
20170208-ECON \
  -d include=score \
  YOUR_HOST/itineraries
Response
{
  “data”: [
    {
      “id”: “DEN-NRT-UA-139-20170206-ECON.NRT-DEN-UA-138-
20170208-ECON”,
      “links”: {
        “score”: 8.8
      }
    }
  ],
  “linked”: {
    “scores”: [
      {
        “id”: 8.8,
        “word_score”: “Excellent”
      }
    ]
  }
}
```

TABLE 13
Itinerary Scores Example #2
Fetching Seat And Wi-Fi Data And Summaries

```
Request
curl \
  -H “Auth: YOUR_API_KEY” \
  -H “Accept: application/vnd.api.v3+json” \
  -G \
  -d ids=DEN-NRT-UA-139-20170206-ECON.NRT-DEN-UA-138-
20170208-ECON \
  -d
include=seat_summary,wifi_summary,legs.segments.seat,legs.-
segments.wifi \
  YOUR_HOST/itineraries
Response
{
  “data”: [
    {
      “id”: “DEN-NRT-UA-139-20170206-ECON.NRT-DEN-UA-138-
20170208-ECON”,
      “links”: {
        “seat_summary”: “2|2”,
        “wifi_summary”: “136|136”,
        “legs”: [
          “DEN-NRT-UA-139-20170206-ECON”,
          “NRT-DEN-UA-138-20170208-ECON”
        ]
      }
    }
  ],
  “linked”: {
    “seat_summaries”: [
      {
        “id”: “2|2”,
        “display_text”: “Above average legroom (32\”)”
      }
    ],
    “wifi_summaries”: [
      {
        “id”: “136|136”,
        “exists”: “yes”,
        “display_text”: “Chance of better Wi-Fi (fee)”
      }
    ],
    “seats”: [
      {
        “id”: 2,
        “display_text”: “Above average legroom (32\”)”,
        “quality”: “better”,
        “legroom”: “more”,
        “pitch”: “32”,
        “width”: “standard”,
        “flatness”: “not flat”,
        “type”: “above average legroom”,
        “updated_at”: “2016-07-01106:09: 52Z”
      }
    ],
    “wifis”: [
      {
        “id”: 136,
        “display_text”: “Chance of better Wi-Fi (fee)”,
        “quality”: “standard”,
        “performance”: “better”,
        “cost”: “paid”,
        “exists”: “yes”,
        “chance”: “very good”,
        “coverage”: “full”,
        “connectivity_type”: “wifi”,
        “type”: “chance”,
        “updated_at”: “2016-05-31110:03:55Z”
      }
    ],
    “segments”: [
      {
        “id”: “DEN-NRT-UA-139-20170206-ECON”,
        “links”: {
          “seat”: 2,
          “wifi”: 136
        }
      },
      {
        “id”: “NRT-DEN-UA-138-20170208-ECON”,
        “links”: {
          “seat”: 2,
          “wifi”: 136
        }
      }
    ],
    “legs”: [
      {
        “id”: “DEN-NRT-UA-139-20170206-ECON”,
        “links”: {
          “segments”: [
            “DEN-NRT-UA-139-20170206-ECON”
          ]
        }
      },
      {
        “id”: “NRT-DEN-UA-138-20170208-ECON”,
        “links”: {
          “segments”: [
            “NRT-DEN-UA-138-20170208-ECON”
          ]
        }
      }
    ]
  }
}
```

### Segments Endpoint

In the following example (Table 14), a session is illustrated of sending a request to the S&A API system for a particular segment of a flight and receiving a response. This endpoint returns a segments collection. The command, parameters, response and resource attributes are indicated in Table 14.

TABLE 14
Session for Segments Endpoint
Request
GET/segments
Parameters

| Name | Required | Description |
|---|---|---|
| ids | Yes | Comma-delimited list of segment keys. |
| include | No | Comma-delimited list of related resources to |
| | | include. By default, this endpoint does not |
| | | return any related resources. |

Response
Resource Attributes
segment

| Name | Value set | Description |
|---|---|---|
| id | e.g. BOS-DEN-DL-123-20990224- | Segment key |
| | ECON | |

Available data elements for the Segment include the following:

Aircraft

Seat

Layout

Entertainment

Wi-Fi

Power

Fresh food

### Certification

The over-all system uses the OAG global flight schedule as an index for providing Scores & Amenities as well as Universal Product Attributes (UPAs) & Universal Ticketing Attributes (UTAs). Requests to the APIs require that valid flight segments are provided in order to accurately match data to a specific flight cabin. If the system cannot recognize a requested flight segment, it simply will not return data for the flight. Occurrences of unrecognized segments are logged and reported as the “Match Rate,” which provides a metric for the health of the customer integration.

### Match Rate

The Match Rate is a core indicator for how often users are seeing Scores & Amenities or UPAs & UTAs in one's application or website. A low Match Rate should be looked at carefully and underlying drivers addressed. Scores & Amenities customers can view their current Match Rate via a dashboard or a system-generated daily activity email.

### Match Rate Drivers

In addition to the Match Rate, the system analyzes the unrecognized segments and reports the top drivers and reasons why it could not match the segments. For example, a requested carrier may not exist in the schedule or fly a particular route on a specific day. Whatever the reasons, it is important to address the top drivers and regularly tune one's integration as new issues emerge. All customers must maintain an acceptable average Match Rate to maintain Certification.

### Other Aspects

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. A computer program product including a computer readable medium having computer program logic stored therein to enable a computer system and application programming interface (API) to collect sets of information on attributes of flights and flight amenities, to store this information and to provide the means to determine a numerical composite flight score, word scores and other quality indicators and evaluations and to provide a means for presenting said scores and quality indicators in numerical, textual and/or graphical forms for each segment and leg of an itinerary to potential users.

2. The means of presenting said scores and quality indicators as in claim 1 to potential integrators including but not limited to travel reservations system providers, airlines, global distribution systems (GDS), Corporate Booking Tools and travel search services who in turn make said scores and indicators available to consumers through various search engines and travel service provider systems.

3. An API of claim 1 that further provides a means for third parties across multiple platforms to integrate said scores and quality indicators into their own travel planning systems.

4. An application programming interface (API) as in claim 1 that conforms to the JSON API specification.

5. An API of claim 1 that is further comprised of a means to compute and display travel duration and to compare it to other flight schedules to determine a value relative to the shortest duration option.

6. A means to determine flight scores and word scores as in claim 1 which is a composite of scores of various attributes formed as a linear combination with weighting factors derived from various inputs. Said over-all numerical score is on a scale of 1.0 to 10.0 where 10.0 is the best possible score.

7. The computer program as in claim 1 that collects and stores flight amenities wherein said amenities include one or more of the following: entertainments options, Wi-fi availability, power outlets, and fresh foods.

8. The computer program as in claim 1 that stores attributes of flight wherein said attributes include one or more of the following: aircraft designation, aircraft layout and seat attributes.

9. An application programming interface (API) as in claim 1 that includes a means to adapt to the form and operating environment of the output devices.

10. The computer program as in claim 1 wherein said means of presenting scores and quality indicators includes pop-up messages upon hovering over an icon or other reference point on the display.

11. A computer system for travel planning comprising a computer and a computer readable medium having computer program logic stored therein to enable a computer system and application programming interface (API) to collect sets of information on attributes of airline flights and flight amenities, to store this information and to provide the means to determine composite flight scores, word scores and other quality indicators and to provide a means for presenting said scores and quality indicators in numerical, textual and/or graphical forms for each leg of an itinerary.

12. The system of claim 11 that includes a means to adapt to the needs of potential integrators including but not limited to travel reservations system providers, airlines, global distribution systems (GDS), Corporate Booking Tools and travel search services who in turn make said scores and indicators available to consumers through various search engines and travel service provider systems.

13. The system of claim 11 wherein the API further provides a means for third parties across multiple platforms to integrate said scores and quality indicators into their own travel planning systems.

14. The system of claim 11 wherein the API conforms to the JSON API specification.

15. The API of claim 11 that is further comprised of a means to compute and display travel duration and to compare it to other flight schedules to determine a value relative to the shortest duration option.

16. The system of claim 11 in which a composite of scores of various attributes is formed as a linear combination with weighting factors derived from various inputs. Further, said composite flight score is on a scale of 1.0 to 10.0 where 10.0 is the best possible score.

17. A system as in claim 11 wherein said means of presenting scores and quality indicators includes pop-up messages upon hovering over an icon or other reference point on the display.

18. A method for collecting sets of information on attributes of airline flights and flight amenities, to store this information and to determine a set of objective evaluations of amenities that can subsequently be used to determine composite flight scores, word scores and other quality indicators and to provide a method for presenting said scores and quality indicators in numerical, textual and/or graphical forms for each leg of an itinerary.

19. The method of claim 18 comprising an application programming interface (API) that includes a method to adapt to the needs of potential users (hereinafter referred to as system integrators) including but not limited to travel reservations system providers, airlines, global distribution systems (GDS), Corporate Booking Tools and travel search services available to consumers through various search engines and travel service provider systems. Said interface provides a means for system integrators to use different aspects of the system in different display options.

20. The API of claim 1 that further provides a certification process for system integrators comprised of a method for identifying Match Rate Drivers and determining a Match Rate that is an indicator of matching flight segments with a specific flight cabin.
